(19) United States
(12) Patent Application Publication
(10) Pub. No.: US 2020/0111119 A1
(43) Pub. Date: Apr. 9, 2020

(54) SYSTEM AND METHOD OF HYPER LOCALLY TARGETING MEDIA CONTENT

(71) Applicant: CARTHERO TECHNOLOGIES PVT LTD, Bengaluru (IN)

(72) Inventors: Vatsal Singhal, Bengaluru (IN); Adhit Shet, Bengaluru (IN); Nagagnanesh Chilukuri, Bengaluru (IN); Mukunda Nallur Srinivasa Gowda, Bengaluru (IN); Viral Chhajer, Bengaluru (IN)

(73) Assignee: Carthero Technologies Pvt Ltd, Bengaluru (IN)

(21) Appl. No.: 16/309,472

(22) PCT Filed: Jun. 7, 2017
(86) PCT No.: PCT/IN2017/050231

§ 371 Date: Dec. 13, 2018

(51) Int. Cl. G06Q 30/02; G06Q 10/08; H04N 21/81; G09F 19/22; G06F 3/01; G01S 19/01

(52) U.S. Cl. CPC G06Q 30/0251; G06Q 30/0277; G06Q 10/0833; G01S 19/01; G09F 19/22; G06F 3/013; H04N 21/812

(57) ABSTRACT

A system and method for hyper-locally targeting media content comprises a portable media device, a memory unit, and a processor. The memory unit stores a database comprising records associated with the media content item, and a set of program modules. The processor executes the set of program modules. An input module receives from at least one user terminal at least one image and a location reference. Further, the input module receives from at least one server a traffic density data, and a second demographic data set. A viewer count estimation module analyzes the at least one image and estimates a second viewer count based on analysis. An output module renders the media content item via a portable media device, based on the first viewer count being lesser than the second viewer count, and the first demographic data set being identical to the second demographic data set.

### CROSS REFERENCE TO APPLICATION

This patent application claims the benefit of PCT Application PCT/IN2017/050231 filed on 7 Jun. 2017. The above application is incorporated by reference herein in its entirety.

### BACKGROUND OF THE INVENTION

### A. Technical Field

The present invention generally relates to the technical field of rendering media content, and more specifically relates to a system and method for hyper locally targeting media content.

### B. Description of Related Art

The advent of portable computing devices like laptops, palm tops, and smart phones in the last two decades has gifted advertisement industry with a plethora of novel methods of advertising. The past two decades have witnessed an exponential increase in number of web-based advertisements, telephonic advertisements, and mobile applications based applications.

Today, the portable computing devices are often integrated with location detecting devices such as Global Positioning System (GPS) trackers, capable of determining location references associated with the portable computing devices. Furthermore, the portable computing devices are integrated with cameras and advanced digital signals processors capable of executing complex image processing and eye tracking algorithms. Images received from the camera can potentially be used to determine the number of people looking at the camera (viewer count). Information such as viewer count and location reference can potentially be used to facilitate hyper local targeting of advertisements to specific demographic groups living in a geographical precinct. Further, such information can be potentially used to ensure that a media content comprising the advertisement receives a substantial number of views. However, current advertisement systems fail to utilize such information and fail to facilitate hyper local targeting of the media content.

Thus, there is a need for a system and method for facilitating hyper local targeting of media content.

### SUMMARY OF THE INVENTION

The present invention relates to a system and method for hyper-locally targeting media content.

In one embodiment of the present invention, a system for hyper-locally targeting media content comprises a portable media device, a memory unit, and a processor. The portable media device is configured to render a media content item. The memory unit to store a database comprising one or more records associated with the media content item, and a set of program modules. The one or more records comprise a first viewer count associated with the media content item, and a first demographics data set associated with the media content item. The processor executes the set of program modules. The set of program modules comprises a viewer count estimation module, an input module, and an output module. The input module is configured to receive from at least one user terminal, at least one image of a crowd of people in vicinity of the at least one user terminal. Further, the input module is configured to receive from the at least one user terminal, a location reference associated with the at least one user terminal. Furthermore, the input module is configured to receive from at least one server a traffic density data associated with the location reference, and a second demographic data set associated with the location reference. The viewer count estimation module, executed by the processor, configured to analyze the at least one image with a plurality of image processing and eye-tracking algorithms, analyze the traffic density data, and estimate a second viewer count associated with the crowd of people based on analysis of the at least one image and the traffic density data. The output module, executed by the processor, is configured to render the media content item via the portable media device, based on the first viewer count being lesser than the second viewer count, and the first demographic data set being identical to the second demographic data set.

In another embodiment of the present invention, the portable media device is at least one of a Liquid Crystal Display screen, a Light Emitting Diode based display screen, an E-ink based display screen, an audio speaker, a mobile digital billboard, a three-dimensional digital billboard, a holographic projector, and a tablet computer. The media content item is at least one of an image, a video, an audio, a text, and a holographic projection. The location reference is at least one of a Global Positioning System (GPS) coordinate, and a Cartesian coordinate. The at least one user terminal is at least one of a smart phone, a tablet computer, a personal computer, a personal digital assistant and a laptop.

In one embodiment of the present invention, the method comprises storing in a memory unit, a database comprising one or more records associated with a media content item, and a set of program modules, wherein the one or more records comprise a first viewer count associated with the media content item, and a first demographics data set associated with the media content item. The method further comprises receiving from at least one user terminal, by a processor via an input module, at least one image of a crowd of people in vicinity of the at least one user terminal. Moreover, the method comprises, receiving from the at least one user terminal, by the processor via the input module, a location reference associated with the at least one user terminal. Furthermore, the method comprises receiving from at least one server, by the processor via the input module, a traffic density data associated with the location reference, and a second demographic data set associated with the location reference. Further, the method comprises analyzing, by the processor via a viewer count estimation module, the at least one image with a plurality of image processing and eye-tracking algorithms. Furthermore, the method comprises analyzing, by the processor via the viewer count estimation module, the traffic density data. Moreover, the method comprises estimating, by the processor via the viewer count estimation module, a second viewer count associated with the crowd of people based on the analysis. Moreover, the method comprises rendering the media content item via a portable media device, by the processor via an output module, based on the first viewer count being lesser than the second viewer count, and the first demographic data set being identical to the second demographic data set.

### BRIEF DESCRIPTION OF DRAWINGS

FIG. 1 is a block diagram of an environment implemented in accordance with various embodiments of the invention.

FIG. 2 exemplarily illustrates a delivery bag, in accordance with one embodiment of the present invention.

FIG. 3 exemplarily illustrates a screenshot of a computer screen configured to display locations of each of the delivery men on a pictorial map, in accordance with one embodiment of the present invention.

FIG. 4 exemplarily illustrates a screenshot of a computer screen configured to present a user with an order screen to place orders for delivery of parcels, in accordance with one embodiment of the present invention.

FIG. 5 exemplarily illustrates a screenshot of a computer screen configured to display a list of orders and associated details associated with each of the list of order, in accordance with one embodiment of the present invention.

FIG. 6 exemplarily illustrates a screenshot of a computer screen configured to display each of the list of orders and names of the delivery men to whom each order has been assigned, in accordance with one embodiment of the present invention.

FIG. 7 exemplarily illustrates of a screenshot of a create advertisement form, in accordance with one embodiment of the present invention.

FIG. 8 is a flow chart of a method of hyper locally targeting media content, in accordance with one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

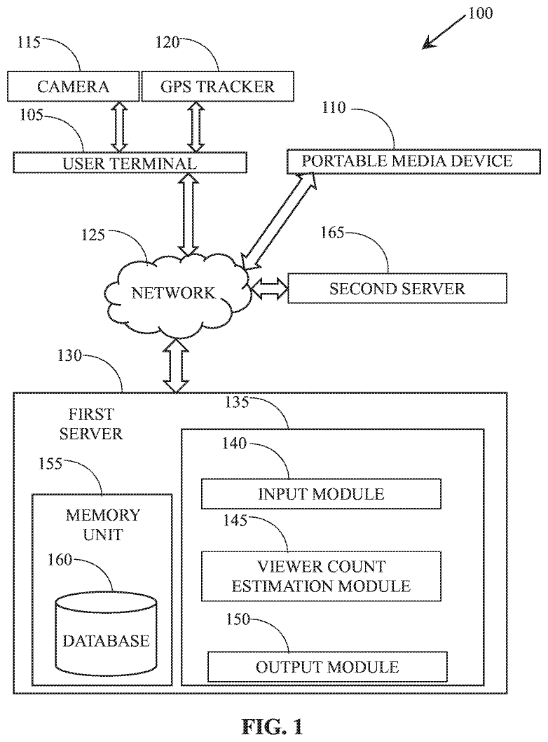

FIG. 1 is a block diagram of an environment 100 implemented in accordance with various embodiments of the invention. The environment 100 comprises a user terminal 105, a portable media device 110, a network 125, a first server 130, and a second server 165. The user terminal 105 is at least one of a personal computer, a laptop, a smart phone, a personal digital assistant, and a tablet computer. The user terminal 105 receives image files and video files from a camera 115. In one example, the camera 115 records one of an image of a crowd of people present in vicinity of the user terminal 105. In another example, the camera 115 records a video of the crowd of people in vicinity of the user terminal 105. The camera 115 is at least one of a digital single lens reflex (DSLR) camera 115, a web camera 115, a camcorder, a drone mounted camera 115, a mobile camera 115, and a button camera 115. In one example, the camera 115 is a GOPRO™ camera 115.

Further, the user terminal 105 receives a location reference from a Global Positioning System (GPS) tracker 120. The location reference is at least one of a GPS coordinate and a Cartesian coordinate of location of the user terminal 105.

In an exemplary illustration of the working of the present invention, the user terminal 105 is carried by at least one of human personnel and a vehicle through different paths within a geographical precinct. In one example, the environment 100 comprises a plurality of user terminals (not shown). The plurality of user terminals receives location references of each of the plurality of user terminals via a plurality of GPS trackers (not shown).

The user terminal 105 transmits the location reference and the image to the first server 130 via the network 125. The network 125 is at least one of a mobile network and a wide area network. The network 125 connects the second server 165, the user terminal 105 and the portable media device 110 with the first server 130.

The first server 130 hosts a system for hyper-locally targeting media content. Examples of media content includes, but is not limited to an image, a video, an audio, a text, and a holographic projection. A media content item is configured to be rendered by the portable media device 110.

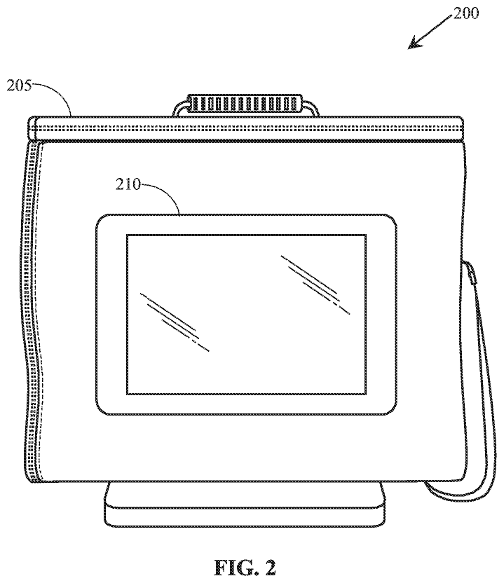

The portable media device 110 is at least one of a Liquid Crystal Display screen, a Light Emitting Diode based display screen, an E-ink based display screen, an audio speaker, a mobile digital billboard, a three-dimensional digital billboard, a holographic projector, and a tablet computer. In one example, the portable media device 110 is integrated with the user terminal 105. In another example, the portable media device 110 is in communication with the first server 130 via the network 125. In one example, the portable media device 110 is replaced with static printed media content item such as printed flex boards and printed posters. In one example, the portable media device 110 is incorporated outside delivery bags of parcel delivery men. FIG. 2 exemplarily illustrates a delivery bag 200, in accordance with one embodiment of the present invention. The delivery bag 200 a container portion 205 to comprise a plurality of good and a portable media device 210. The portable media device 210 is at least one of a Liquid Crystal Display, a light emitting diode display and an e-ink based display.

Referring the FIG. 1 again, in another example, delivery details associated with each order served by the delivery men are recorded in a memory unit 155. In one example, a computer (not shown) is configured to display locations of each of the delivery men on a pictorial map. The computer is also configured to present a user with an order screen to place orders for delivery of parcels. Furthermore, the computer displays a list of orders and associated details associated with each of the list of order. Moreover, the computer displays each of the list of orders and names of the delivery men to whom each order has been assigned. In an embodiment, the computer displays hours the portable media device 110 is used for advertising, time spent by the portable media device 110 in a specific area, name and history of a delivery man who is carrying the portable media device 110 within a specific area, product delivered by the delivery man carrying the portable media device 110 within the specified area. In an embodiment, the computer displays current locations of the plurality of delivery men carrying the portable media device 110. Further, the computer determines a location specific advertisement campaign and displays the location specific advertisement campaign through the portable media device 110 based on a plurality of demographic data sets received by the user terminal 105. In one example, the computer displays total amount of distance covered by each of the delivery men. In one example, the computer is the user terminal 105.

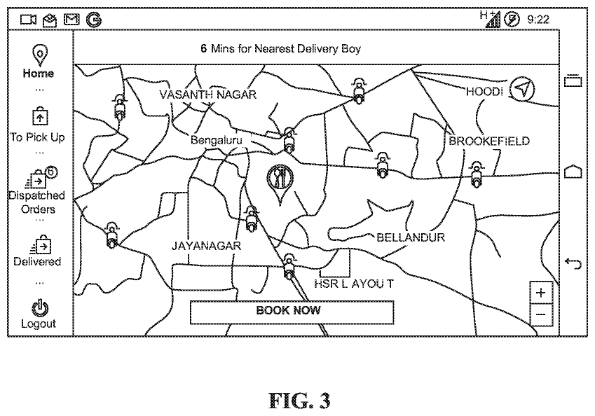

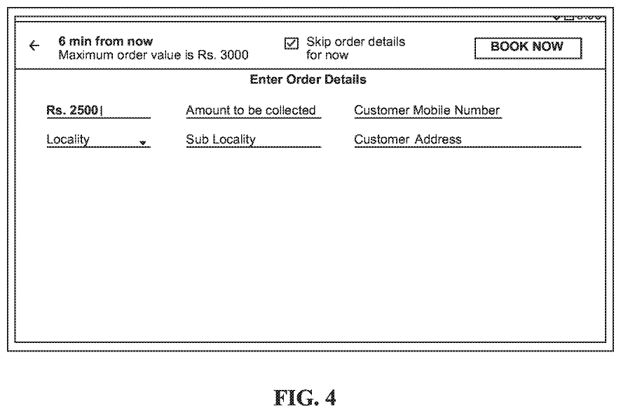

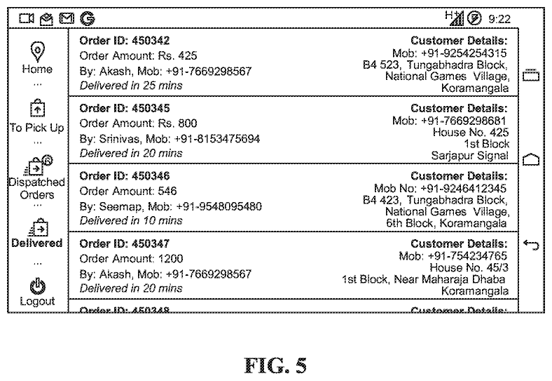

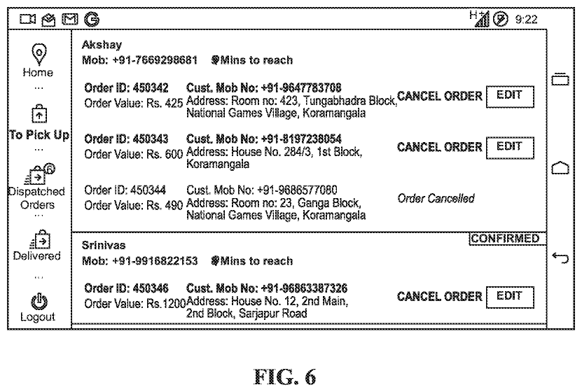

FIG. 3 exemplarily illustrates a screenshot of a computer screen configured to display locations of each of the delivery men on a pictorial map, in accordance with one embodiment of the present invention. FIG. 4 exemplarily illustrates a screenshot of a computer screen configured to present a user with an order screen to place orders for delivery of parcels, in accordance with one embodiment of the present invention. FIG. 5 exemplarily illustrates a screenshot of a computer screen configured to display a list of orders and associated details associated with each of the list of order, in accordance with one embodiment of the present invention. For example, the list of orders comprises customer order number, the amount of purchase order associated with the customer order number, customer contact details, delivery time required for delivering goods to a delivery location. FIG. 6 exemplarily illustrates a screenshot of a computer screen configured to display each of the list of orders and names of the delivery men to whom each order has been assigned, in accordance with one embodiment of the present invention.

Referring to FIG. 1 again, the first server 130 comprises the memory unit 155 and a processor 135. The memory unit 155 stores a database 160 comprising one or more records associated with the media content item, and a set of program modules. The one or more records comprise a first viewer count associated with the media content item, and a first demographics data set associated with the media content item. The system hyper locally targets the media content item to as many number of viewers as the first view count. The first demographic data set comprises age groups of people living within a locality, religions of people living in a locality, diet preferences of people living in a locality, and fashion preferences of people living in a locality.

In one example, the media content item is an advertisement. The first demographic data set associated with the advertisement is received from the user via a create advertisement form. In an embodiment, the user terminal 105 assigns the user with one of an administrator privilege and a normal user privilege. The user is further enabled to customize the advertisement either automatically or manually. The normal user privilege allows the user to view general information such as status of delivery of the advertisement, the current location of each of the plurality of delivery men, the areas covered by the delivery men, and the advertisement being displayed on the portable media device 110. The administrator privilege allows the user to view at least one profile of the plurality of delivery men, view the real-time statistics associated with the user terminal 105, and automatically configure the advertisement for each of the plurality of men. The user terminal 105 is configured to determine number of views received for the advertisement displayed portable media device 110. In one example, the user terminal 105 collects information such as number of billboards required to display the advertisement, locality wise delivery men required to be assigned for displaying the advertisement, number of hours' promotions needed to be run in the portable media device 110 carried by each of the plurality of delivery men. In an embodiment, the user terminal 105 is configured to perform analytics based on number of views on the advertisement, utilization of the portable media device 110, at least one user profile of each of the plurality of delivery men, and real-time statistics captured for at least one advertisement campaign. In an embodiment, the first server 130 captures Short Message Service (SMS) messages received from vicinity of the location reference.

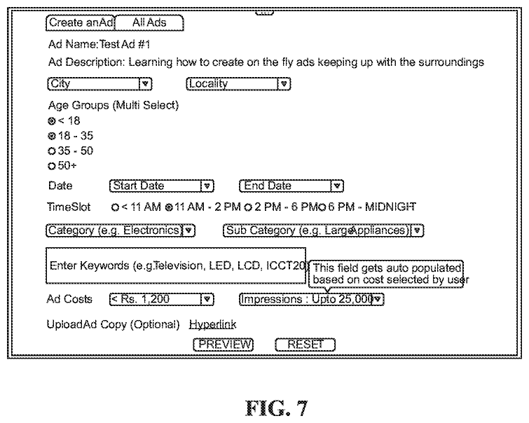

FIG. 7 exemplarily illustrates a screenshot of a create advertisement form, in accordance with one embodiment of the present invention. In an embodiment, a user with an administrator privilege is enabled to create an advertisement campaign based on a plurality of different criteria. For example, the user is enabled to assign a specific advertisement to a portable media device if population of adolescent persons in a specific locality increases between 11:00 AM in the morning and 2:00 PM in the afternoon.

Referring to FIG. 1 again, the form comprises data fields to enter name of an advertisement, description of the advertisement, age groups to whom the advertisement must be targeted, date to begin displaying the advertisement, the date to end displaying the advertisement, time slot when advertisement must be displayed, category of products to which the advertisement is directed to, cost of the advertisement, and the first viewer count associated with the advertisement. The system hyper locally targets the media content item to audience belonging to the first demographic data set.

The processor 135 executes the set of program modules. The set of program modules comprises an input module 140, a viewer count estimation module 145, and an output module 150. The input module 140 receives from at least one user terminal 105, the image of a crowd of people in vicinity of the user terminal 105. The image is at least one of a .jpeg image, a .bmp image, and a .png image.

Further, the input module 140 receives from the at least one user terminal 105, the location reference associated with the at least one user terminal 105. Furthermore, the input module 140 receives a traffic density data from the second server 165. The second server 165 comprises real time traffic density data and statistics of areas under the geographical precinct. The second server 165 transmits the traffic density data in areas in vicinity of the location reference. The traffic density data comprises number of vehicles in vicinity of the location reference, speed of the vehicles in vicinity of the location reference, and size of the vehicles in vicinity of the location reference. Further, the second server 165 comprises demographic data sets of the areas under the geographical precinct. The second server 165 transmits a second demographic data set associated with the location reference to the first server 130. In one example, the second server 165 is a google maps server associated with a google maps application. The input module 140 transmits the image, the location reference, and the traffic density data into the viewer count estimation module 145. The input module 140 transmits the second demographic data set to the output module 150. In one example, the second demographic data set comprise real time statistics. Further, the second demographic data set includes but is not limited to the density of the crowd captured in a specific area, the number of views captured for the advertisement campaign, the number of short messaging service messages (SMS), and social media activity received from the crowd of people in the vicinity of the location reference, and types of products purchased by the crowd of people in the vicinity of the location reference.

The viewer count estimation module 145, is configured to analyze the at least one image with a plurality of image processing and eye-tracking algorithms. In one example, the plurality of image processing and eye tracking algorithms are stored in the memory unit 155. The plurality of image processing and eye tracking algorithms analyze the image of the crowd of people to determine direction of gaze of a plurality of people in the crowd. Further, the viewer count estimation module 145 analyzes the traffic density data. The viewer count estimation module 145 estimates a second viewer count associated with the crowd of people based on analysis of the at least one image and the traffic density data. The viewer count estimation module 145 transmits the second view count to the output module 150.

The output module 150, executed by the processor 135, is configured to render the media content item via the portable media device 110, based on the first viewer count being lesser than the second viewer count, and the first demographic data set being identical to the second demographic data set. In one example, the output module 150 displays the list of advertisements assigned by the user, to the system.

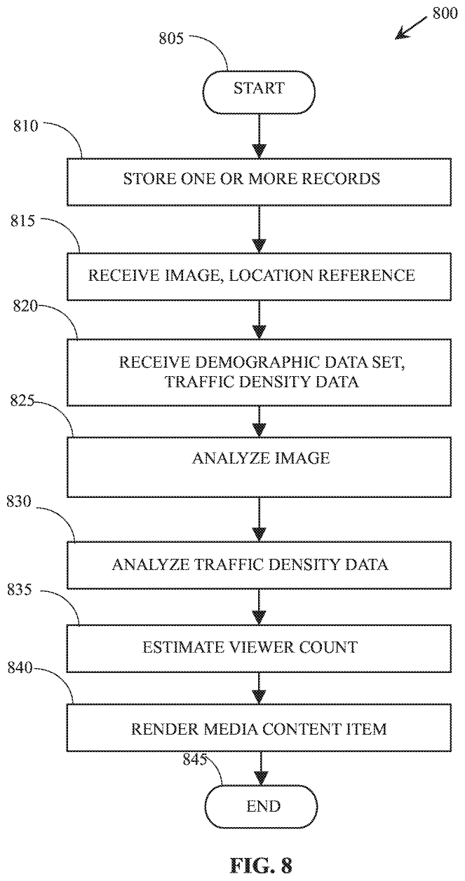

FIG. 8 is a flow chart of a method 800 of hyper locally targeting media content, in accordance with one embodiment of the present invention. The method 800 is implemented in an environment comprising a user terminal, a portable media device, a network, a first server, and a second server. The user terminal is at least one of a personal computer, a laptop, a smart phone, a personal digital assistant, and a tablet computer. The user terminal receives image files and video files from a camera. In one example, the camera records one of an image of a crowd of people present in vicinity of the user terminal. In another example, the camera records a video of the crowd of people in vicinity of the user terminal. The camera is at least one of a digital single lens reflex (DSLR) camera, a web camera, a camcorder, a drone mounted camera, a mobile camera, and a button camera. In one example, the camera is a GOPRO™ camera.

Further, the user terminal receives a location reference from a Global Positioning System (GPS) tracker. The location reference is at least one of a GPS coordinate and a Cartesian coordinate of location of the user terminal.

In an exemplary illustration of the working of the present invention, the user terminal is carried by at least one of human personnel and a vehicle through different paths within a geographical precinct. In one example, the environment comprises a plurality of user terminals (not shown). The plurality of user terminals receives location references of each of the plurality of user terminals via a plurality of GPS trackers (not shown).

The user terminal transmits the location reference and the image to the first server via the network. The network is at least one of a mobile network and a wide area network. The network connects the second server, the user terminal and the portable media device with the first server.

The first server hosts a system for hyper-locally targeting media content. Examples of media content includes, but is not limited to an image, a video, an audio, a text, and a holographic projection. A media content item is configured to be rendered by the portable media device.

The portable media device is at least one of a Liquid Crystal Display screen, a Light Emitting Diode based display screen, an E-ink based display screen, an audio speaker, a mobile digital billboard, a three-dimensional digital billboard, a holographic projector, and a tablet computer. The portable media device is in communication with the first server via the network. In one example, the portable media device is replaced with printed media content item such as printed flex boards. In one example, the portable media device is incorporated outside delivery bags of parcel delivery men. The delivery bag a container portion to comprise a plurality of good and a portable media device. The portable media device is at least one of a Liquid Crystal Display, a light emitting diode display and an e-ink based display.

In another example, delivery details associated with each order served by the delivery men are recorded in a memory unit. A computer screen is configured to display locations of each of the delivery men on a pictorial map. The computer screen is also configured to present a user with an order screen to place orders for delivery of parcels. Furthermore, the computer screen displays a list of orders and associated details associated with each of the list of order. Moreover, the computer screen displays each of the list of orders and names of the delivery men to whom each order has been assigned. In one example, the computer screen displays total amount of distance covered by each of the delivery men.

The first server comprises the memory unit and a processor. The method 800 commences at step 805.

At step 810, the memory unit stores a database comprising one or more records associated with the media content item, and a set of program modules. The one or more records comprise a first viewer count associated with the media content item, and a first demographics data set associated with the media content item. The system hyper locally targets the media content item to as many number of viewers as the first view count. The first demographic data set comprises age groups of people living within a locality, religions of people living in a locality, diet preferences of people living in a locality, and fashion preferences of people living in a locality. In one example, the media content item is an advertisement. The first demographic data set associated with the advertisement is received from the user via a create advertisement form. The form comprises data fields to enter name of an advertisement, description of the advertisement, age groups to whom the advertisement must be targeted, date to begin displaying the advertisement, the date to end displaying the advertisement, time slot when advertisement must be displayed, category of products to which the advertisement is directed to, cost of the advertisement, and the first viewer count associated with the advertisement. The system hyper locally targets the media content item to audience belonging to the first demographic data set.

The processor executes the set of program modules. The set of program modules comprises a viewer count estimation module, an input module, and an output module.

At step 815, the input module receives from at least one user terminal, the image of a crowd of people in vicinity of the user terminal. The image is at least one of a. jpeg image, a .bmp image, and a .png image. Further, the input module receives from the at least one user terminal, the location reference associated with the at least one user terminal.

At step 820, the input module receives a traffic density data from the second server. The second server comprises real time traffic density data and statistics of areas under the geographical precinct. The second server transmits the traffic density data in areas in vicinity of the location reference. The traffic density data comprises number of vehicles in vicinity of the location reference, speed of the vehicles in vicinity of the location reference, and size of the vehicles in vicinity of the location reference. Further, the second server comprises demographic data sets of the areas under the geographical precinct. The second server transmits a second demographic data set associated with the location reference to the first server. In one example, the second server is a google maps server associated with a google maps application. The input module transmits the image, the location reference, and the traffic density data into the viewer count estimation module. The input module transmits the second demographic data set to the output module. In one example, the second demographic data set comprise real time statistics.

At step 825, the viewer count estimation module analyzes the at least one image with a plurality of image processing and eye-tracking algorithms. In one example, the plurality of image processing and eye tracking algorithms are stored in the memory unit. The plurality of image processing and eye tracking algorithms analyze the image of the crowd of people to determine direction of gaze of a plurality of people in the crowd.

At step 830, the viewer count estimation module analyzes the traffic density data.

At step 835, the viewer count estimation module estimates a second viewer count associated with the crowd of people based on analysis of the at least one image and the traffic density data. The viewer count estimation module transmits the second view count to the output module.

At step 840 the output module, renders the media content item via the portable media device, based on the first viewer count being lesser than the second viewer count, and the first demographic data set being identical to the second demographic data set. In one example, the output module displays list of advertisements assigned by the user, to the system.

The method 800 ends at step 845.

Advantageously, the system got hyper locally targeting media content facilitates delivery of advertisements for focused and targeted groups. Further, the system enables advertising agencies to establish healthy meaningful relationships with customers. Further, the system facilitates cost-effective mobile advertisement within a network. The system facilitates strategic targeting of advertisements towards groups of people interested in viewing the advertisements.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for hyper-locally targeting media content, the system comprising:
a portable media device is integrated with at least one user terminal configured to display a media content item;
a first server comprises a memory unit and a processor, wherein the memory unit is configured to store:
a database comprising one or more records associated with the media content item, and
a set of program modules,
wherein the one or more records comprise a first viewer count associated with the media content item, and a first demographics data set associated with the media content item;
wherein the processor in communication with the memory unit, configured to execute the set of program modules, wherein the set of program modules comprises:
an input module, executed by the processor, configured to:
receive, via a camera, from at least one user terminal, at least one image or video files of a crowd of people present in vicinity of the at least one user terminal, receive, via a Global Positioning System (GPS) tracker, from the at least one user terminal, a location reference associated with the at least one user terminal,
wherein the user terminal is incorporated on a delivery bag carried by at least one human personnel or vehicle through different paths within a geographical precinct, and
wherein the user terminal transmits the location reference and the image to the first server via a network, and
receive from at least one second server:
a real time traffic density data associated with the location reference, and
a second demographic data set associated with the location reference,
wherein the network connects the second server, the user terminal and the portable media device with the first server;
a viewer count estimation module, executed by the processor, configured to:
analyze the at least one image with a plurality of image processing and eye-tracking algorithms,
analyze the traffic density data, and
estimate a second viewer count associated with the crowd of people based on analysis of the at least one image and the traffic density data; and
an output module, executed by the processor, configured to display the media content item via the portable media device, based on:
the first viewer count being lesser than the second viewer count, and
the first demographic data set being identical to the second demographic data set.

2. The system of claim 1, wherein the portable media device is at least one of a Liquid Crystal Display screen, a Light Emitting Diode based display screen, an E-ink based display screen, an audio speaker, a mobile digital billboard, a three-dimensional digital billboard, a holographic projector, and a tablet computer.

3. The system of claim 1, wherein the media content item is at least one of an image, a video, an audio, a text, and a holographic projection.

4. The system of claim 1, wherein the location reference is at least one of a Global Positioning System (GPS) coordinate, and a Cartesian coordinate.

5. The system of claim 1, wherein the at least one user terminal is at least one of a smart phone, a tablet computer, a personal computer, a personal digital assistant and a laptop.

6. A computer-implemented method of hyper-locally targeting media content, the method comprising:
storing in a memory unit, a database comprising one or more records associated with a media content item, and a set of program modules, wherein the one or more records comprise a first viewer count associated with the media content item, and a first demographics data set associated with the media content item, further comprising a processor in communication with the memory unit, configured to execute the set of program modules;
receiving from at least one user terminal, by the processor via an input module, at least one image of a crowd of people in vicinity of the at least one user terminal, wherein the user terminal is incorporated on a delivery bag carried by at least one human personnel or vehicle through different paths within a geographical precinct;
receiving from the at least one user terminal, by the processor via the input module, a location reference associated with the at least one user terminal;
receiving from at least one server, by the processor via the input module, a traffic density data associated with the location reference, and a second demographic data set associated with the location reference;
analyzing, by the processor via a viewer count estimation module, the at least one image with a plurality of image processing and eye-tracking algorithms;
analyzing, by the processor via the viewer count estimation module, the traffic density data;
estimating, by the processor via the viewer count estimation module, a second viewer count associated with the crowd of people based on the analysis; and
displaying the media content item via a portable media device integrated with at least one user terminal, by the processor via an output module, based on:
the first viewer count being lesser than the second viewer count, and
the first demographic data set being identical to the second demographic data set.

7. The method of claim 6, wherein the portable media device is at least one of a Liquid Crystal Display screen, a Light Emitting Diode based display screen, an E-ink based display screen, an audio speaker, a mobile billboard, a three-dimensional billboard, a holographic projector, and a tablet computer.

8. The method of claim 6, wherein the media content item is at least one of an image, a video, an audio, a text, and a holographic projection.

9. The method of claim 6, wherein the location reference is at least one of a Global Positioning System (GPS) coordinate, and a Cartesian coordinate.

10. The method of claim 6, wherein the at least one user terminal is at least one of a smart phone, a tablet computer, a personal computer, a personal digital assistant and a laptop.
